(19) United States
(12) Patent Application Publication
(10) Pub. No.: US 2017/0228765 A1
(43) Pub. Date: Aug. 10, 2017

(54) METHOD AND SYSTEM FOR ADJUSTING THE DISPLAY OF ADVERTISEMENTS

(71) Applicant: Google Inc., Mountain View, CA (US)

(72) Inventors: Alex Carobus, Mountain View, CA (US); Jonathan Rosenberg, Mountain View, CA (US); Narayanan Shivakumar, Mountain View, CA (US); Brian Axe, Mountain View, CA (US)

(73) Assignee: Google Inc., Mountain View, CA (US)

(21) Appl. No.: 15/495,489

(22) Filed: Apr. 24, 2017

Related U.S. Application Data
(63) Continuation of application No. 10/939,502, filed on Sep. 14, 2004, now abandoned.

(51) Int. Cl. G06Q 30/02

(52) U.S. Cl. CPC G06Q 30/0244; G06Q 30/0245; G06Q 30/0257

(57) ABSTRACT

Methods and systems that allow a user (e.g., an Internet distribution partner of an advertisement listings provider, etc.) to selectively adjust the display of advertisements through an online interface. For example, an embodiment of the present invention allows users (e.g., publishers, account managers, etc.) to adjust the targeting of content advertisements on individual URLs, domains, properties, etc. Users can manually replace advertisements or apply various filters used to generate advertisements.

### FIELD OF THE INVENTION

The present inventions relate generally to enabling publishers, account managers, and other entities to selectively adjust the display of advertisements on various target sites, including individual URLs, domains and properties.

### BACKGROUND OF THE INVENTION

With the advent of the Internet, advertising over more interactive media has become popular. Merchants and their advertising agents (individually and collectively, “advertisers”) have developed several strategies in an attempt to maximize the value of such advertising. For example, advertisers may place advertisements on home pages of various web sites (e.g., news web sites, search engines, etc.). Advertisers try to target advertisements to a more narrow audience in order to increase the likelihood of a positive response by the audience. For example, a hotel in Las Vegas may promote special discounts on a travel web site, specifically on the web pages directed to Las Vegas vacations. The advertisements typically include a link to the advertiser's web site where the user can purchase the advertised product or service.

Current content advertisement systems do not allow for human intervention in advertisement targeting. As a result, when badly targeted advertisements are found, there is generally nothing that can be done except remove the advertisements completely. Badly targeted advertisements may include offensive, inappropriate or even non-existent advertisements, which result in a loss of opportunity, negative publicity and waste of resources, along with other inefficiencies.

These and other drawbacks exist with current systems and methods.

### SUMMARY OF THE INVENTION

Various embodiments of the present invention relate to methods and systems that allow a user (e.g., Internet distribution partner of an advertisement listings provider, publishers, account managers, etc.) to selectively adjust the display of advertisements through an interface. For example, an embodiment of the present invention allows users to adjust the targeting of content advertisements on individual URLs, domains, properties, etc. Users can manually replace advertisements or apply various criteria used to generate advertisements.

In accordance with an exemplary embodiment, method of tuning advertisements comprises delivering to a user a first set of one or more advertisements related to a concept from a database of advertisements; receiving one or more tuning criteria from the user; delivering a second set of one or more advertisements to the user from the database, the second set of advertisements related to the concept and based on the one or more tuning criteria; and applying the tuning criteria for use in delivering future sets of advertisements.

In accordance with another exemplary embodiment, a method of distributing advertisements comprises receiving a request for advertisements from a distribution system; identifying at least one concept for advertisements to be delivered; identifying tuning criteria of the distribution system requesting advertisements; and selecting advertisements based on the at least one concept and the tuning criteria.

Other advantages of the various embodiments of the present invention will be appreciated from a review of the detailed description that follows.

### BRIEF DESCRIPTION OF THE DRAWINGS

FIG. 1 is a schematic diagram of a system of providing adjusted advertisements, according to an embodiment of the present invention.

FIG. 2 is an example of flowchart illustrating a method for adjusting the display of advertisements, according to an embodiment of the present invention.

FIG. 3 is an exemplary diagram illustrating a system for adjusting the display of advertisements, according to an embodiment of the present invention.

### DETAILED DESCRIPTION OF THE EMBODIMENTS

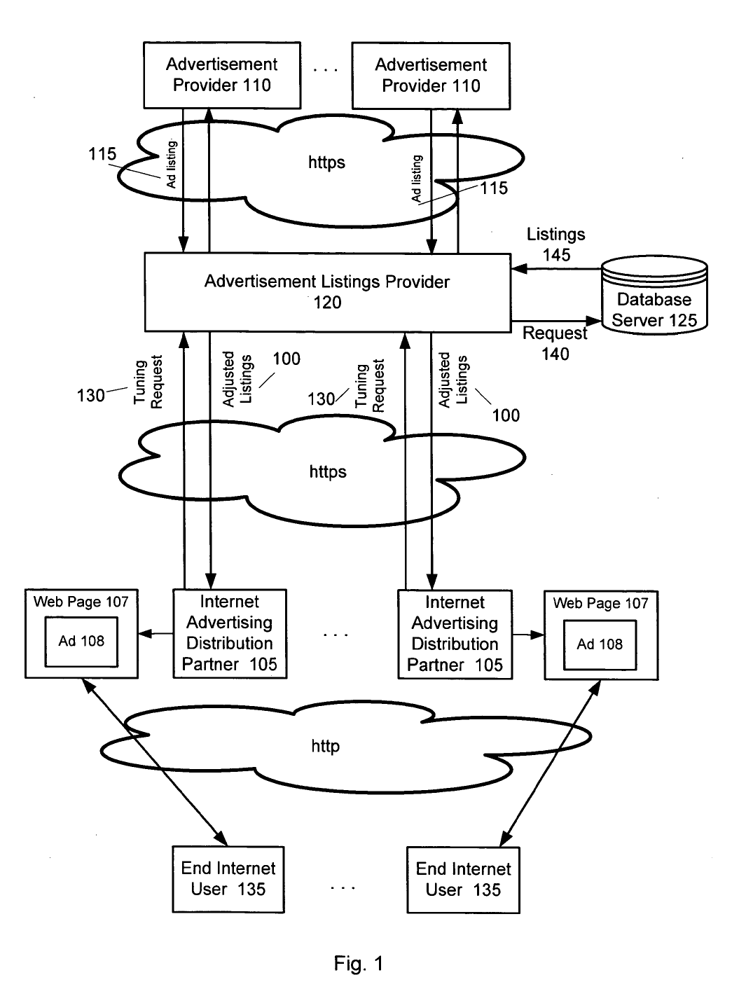

Various embodiments of an advertisement distribution system are described below. An overview of the system 10 is depicted in FIG. 1.

Overview and System Architecture

FIG. 1 is a schematic diagram of a system that enables a user (e.g., Internet advertising distribution partner 105) to selectively adjust the display of advertisements, according to an embodiment of the present invention. In the present embodiment, at least one advertisement provider 110 submits its advertisement listings to the advertisement listings provider 120. In the present embodiment two (2) advertisement providers 110 are shown, although it is understood that any number of advertisement providers 110 may submit advertisement listings 115 to an advertisement listings provider 120. Moreover, an individual advertisement provider 110 may submit more than one advertisement listing 115 to advertisement listings provider 120. An advertisement listing 115 may include all or part of the following information fields, some of which are supplied by the advertising provider and some of which are stored by the advertising provider (e.g., the advertisement ID number): the name of the advertisement provider, a title of the advertisement, a description of the goods or services advertised, a URL to be displayed in the listing, where an end user will be directed upon clicking on the advertisement, contact information, an email address, billing information, pricing information, an advertisement identification number and/or other information.

According to an embodiment of the present invention, the advertising listings provider 120 may rank the advertisement listings submitted (e.g., by keyword, subject or otherwise) and store the ranked listings in a database server 125. The rank that an advertisement listing 115 is assigned may depend upon the bid the advertisement provider 100 offers the advertisement listings provider 120 for a “click-through.” For example, the price may be a flat rate for placement or a price per end Internet user 135 who selects the advertisement, often referred to as price-per-click through. Also, the ranking may be based on a revenue model as disclosed in co-pending application No. 60/406,064, filed Aug. 27, 2002, entitled “Method and System for Providing Advertising Listing Variance in Distribution Feeds over the Internet,” the entirety of which is hereby incorporated by reference. The advertisement listing 115 may contain a hyperlink so that an end Internet user 135 may select the advertisement and be redirected to a predetermined web site defined in the advertisement listing 115.

An Internet advertising distribution partner 105 may maintain a web site 107. An end Internet user 135 may access that web site via an http connection. According to an embodiment of the present invention, an Internet advertising distribution partner 105, such as a retailer, may selectively adjust the display of advertisements, as represented by 108 on web site 107. Adjustment criteria may be sent to the advertisement listings provider 120, via a tuning request 130. The tuning request 130 may direct that certain criteria be applied to the advertisements for display on web site 107. Also, the criteria may be stored in various locations, such as tuning database 127, or the criteria may not be stored at all, but defined each time a tuning request 130 is generated. For example, the criteria may identify the characteristics the Internet advertising distribution partner 105 wishes to include or exclude from the advertisement listings 115 received.

Upon receiving a tuning request 130, the advertisement listings provider 120 may send a request 140 to the database server 125. In one embodiment of the present invention, the tuning request may include various criteria to be replaced. The criteria may also be applied to further narrow the advertisements for display. The database server 125 may return available listings 145. These listings 145 may or may not be ranked. The advertisement listings provider 120 may then apply the requested tuning which may be stored in a tuning database and send adjusted listings 100 to the Internet advertising distribution partner 105. The Internet advertising distribution partner 105 may then dynamically include information from the adjusted listings 100 in its web site content delivered to end Internet user(s) 135.

An advertising distribution partner 105 may transmit a tuning request 130 for each request of a web page (or other target) to contain the adjusted listings 100 due to the dynamically changing content of listings, rankings, etc. It should be appreciated that advertising distribution partner 105 may cache the adjusted listings to reduce the number of requests to advertisement listings provider 120. The cache may be used for minutes, hours, etc., as desired. In addition, the distribution advertising partner 105 may also submit a tuning request that can be applied to some or all future displays of advertisements or for a predetermined period of time.

Internet advertising distribution partner 105 may comprise a web site and any structure, software and network connections to implement that functionality. End Internet users 135 may connect using an Internet-compatible device. Similarly, advertisement providers 110 may connect to advertisement listings provider 120 using any Internet-compatible device. Database server 125 may comprise any data storage system accessible and usable with an Internet-based server system such as advertisement listings provider 120. Variations to the systems shown in FIG. 1 may be made as known those or ordinary skill in the art, such as by enabling some of the network connections to be made over a network other than the Internet or making connections secure or non-secure as deemed appropriate. As described above, the advertisement and tuning criteria may be stored in database server 125.

End Internet user 135 may view the adjusted listings 100 on the web site 107 of the Internet advertising distribution partner 105. In this particular embodiment, there are two (2) Internet advertising distribution partners 105 shown. However, it should be understood that any number of Internet advertising distribution partners 105 may be incorporated into the present invention. Additionally, there are two (2) end Internet users 135 shown in this embodiment. However, it should be understood that any number of end Internet users 135 may receive adjusted listings from each Internet advertising distribution partner 105.

Illustrative Tuning Process

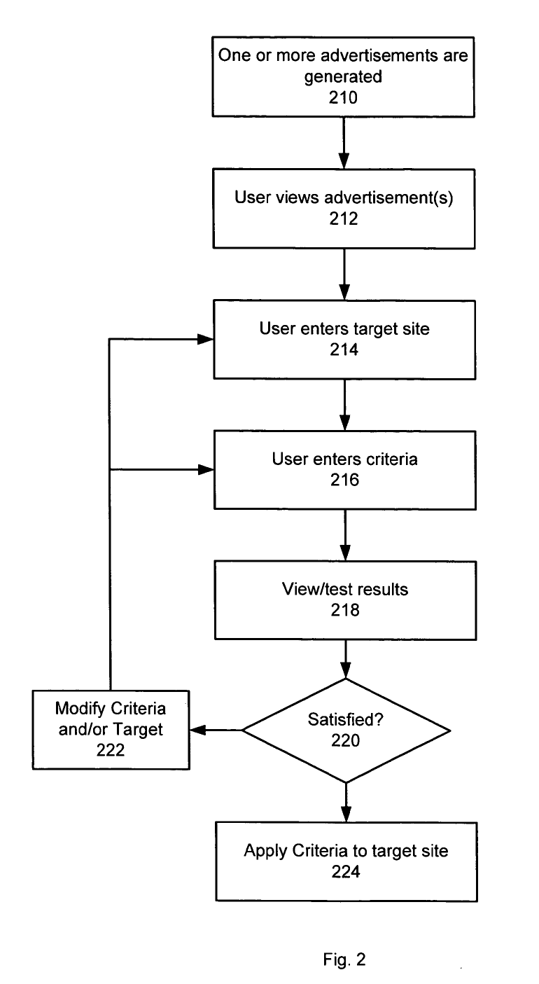

FIG. 2 is an example of flowchart illustrating a method for adjusting the display of advertisements, according to an embodiment of the present invention. At block 210, one or more advertisements are generated. At block 212, a user may view the set of advertisements for relevancy via an interface or console. According to one example, the user may represent an Internet Advertising Distribution Partner 105. At block 214, the user may enter a target site, such as a web page or web site, identified by a URL or other identifier. At block 216, the user may enter criteria for adjusting the display of the set of advertisements. At block 218, the user may view or test the results of the specified adjustments. If the user is not satisfied at block 220, further modifications may be made, as shown by 222. If the user is satisfied, the criteria may be applied to the target site. While the process illustrated in FIG. 2 discloses certain blocks performed in a particular order, it should be understood that the present invention may be practiced by adding one or more blocks to the process, omitting blocks within the process and/or altering the order in which one or more blocks are performed.

At block 210, one or more advertisements are generated. The advertisements may be based on predetermined criteria. For example, the advertisements may be targeted, based on keywords, concepts, etc. The most relevant advertisements may be determined by click through rate and bid rate. Other criteria may be used as well. The advertisements may be determined for relevancy by rank analysis or other method.

Advertisements may be targeted to search results and/or other content pages (e.g., web pages, emails, print media, etc.) on a wide variety of sites and other display environments. Generally, web site providers make advertising space available on their sites as a source of revenue. The more the end-user is interested in an advertisement, the more likely the end-user will select the advertisement. By selecting the advertisement, the end-user obtains more information about the product or service being offered and will more likely become a customer. To be competitive, advertising web sites seek to increase the number of times an end-user selects an advertisement relative to the number of impressions the advertisement gets on the site. This statistic may be referred to as a click through rate (CTR). By increasing the CTR, advertisers will be more inclined to advertise on these web sites. Also, in some systems, advertisers pay the advertising system based at least in part on other performance criteria such as conversion rate and the like. While various examples herein are described relative to CTR, it should be appreciated that the conversion rates and performance criteria also apply.

Content-targeted text advertisements may be displayed when the text advertisements relate to the content that the end-user is currently viewing. The content may be accessed by viewing (or listening to) the content by moving a cursor over an associated icon, entering an input at a keyboard or other input device, touching an identifier on a screen such as a hyperlink, or otherwise selecting the content.

Advertisements may be targeted based at least in part on a subject or web content the end-user is currently viewing. Advertisers may purchase content-based concepts, such as keywords or locations in semantic space (a measure of concept relatedness), in some fashion and associate an advertisement with the concepts so that the advertisements may be displayed in connection with relevant content thereby increasing the CTR or other performance parameter. In another example, advertisers may associate advertisements with content pages, identified by content-based concepts. For example, a third party document supplier (e.g., an advertiser) may want to associate a document (e.g., an advertisement) with a subject matter, e.g., baseball, where the resulting content pages may not necessarily have the term “baseball” located anywhere on the content page.

The advertiser may specify a target language and/or target countries. In addition, the advertiser may target a type of customer based at least in part on demographic and/or other data. Further, the advertiser may intend the advertisement to be displayed on documents such as content pages, results of search pages, sounds, and/or other types of audio-visual outputs (as used herein, the term “document” may refer to one or more of these outputs). Content pages may refer to any page that contains content, including web pages, emails, print material or other media. For example, advertisements directed to children may be restricted from display on adult sites or sites that promote violence. The advertiser may selectively choose whether to allow the advertisement to be displayed on syndication sites. Syndication sites may refer to third party web sites that receive advertisements from the provider (e.g., for compensation).

An advertiser may represent an entity providing a service and/or product, such as a merchant. The advertiser may also represent an advertising agent or other entity acting on behalf of the advertiser. (Merchants, agents, and other associated entities are individually and collectively referred to as “advertiser” herein.) The advertiser may be a commercial, private, non-profit, government or other type of entity.

The advertiser may identify one or more concepts, which can trigger a display of the advertisement. For example, the advertisements may be sent to an Internet advertising distribution partner 105 based on concepts they request or that are extracted from their web site or other source. For example, a food delivery service may select keyword concepts such as “food” and “delivery” thereby increasing the likelihood of display of a relevant advertisement. Advertisements associated with the identified concepts may be displayed on the food delivery service web site. Additional groups of concepts may be applied as well. The same food delivery service may select additional groups of concepts to include other concepts, such as “grocery” and “deliver” and may also include another group, which may include a key phrase, such as “food delivery service in Baltimore area.”

In another example, the advertiser may select from a group of potential concepts. For example, a server may automatically extract keywords and other concepts from the advertiser's web site, other designated web page or other location. A list of potential concepts may be displayed for the advertiser to select from. Other methods for associating concepts (e.g., keywords, subject matter, location(s) in semantic space, etc.) with a graphic may be implemented.

In another example, an advertiser may specify content-based concepts directed to a subject matter. For example, an advertiser for car repair service may want to display an advertisement on web pages directed to car repair where the terms “car” and “repair” may or may not appear in the content pages.

At block 212, a user may view the one or more advertisements generated via an interface or console. The user may represent a publisher, Internet advertising distribution partner, an individual site owner, customer or other entity associated with the display of advertisements. In addition, a user may represent an advertising entity. By accessing an interface, the user may fine tune or otherwise modify the display of advertisements generated at block 210. For example, the user may not be satisfied with the results of the automatic generation of advertisements. There may be circumstances where inappropriate advertisement are displayed. In another example, a user may want to further narrow the types of advertisements appearing on a web page or other site. For example, the advertisements generated for a computer store may relate broadly to the topic of “desktop computers.” However, the user may want to focus advertisements directed to “flat screen monitors” to promote a special event at the computer store. Also, the computer store may want to promote a particular brand by tuning the advertisements for display by manufacturer.

At block 214, the user may enter a target site. The target site may include URLs, domains, properties, pages, topics, sites, etc. For example, the user may specify a particular web page or other site, identified by one or more URLs. Targets may include a specific page, entire web site, a plurality of pages or sites and/or other various combinations.

At block 216, the user may enter criteria for adjusting the display of the set of advertisements. Criteria may include concepts, terms, keywords, advertisements, categories, etc. The criteria may be used to replace the current set of advertisements as well as further narrow the current set of advertisements. In addition, terms to avoid may be specified. Further, the user may select to avoid negative and/or offensive (e.g., porn, violent, etc.) advertisements. For example, a cooking knife retailer may want to avoid association with acts of violence. There may be a situation where a news story refers to a murder involving the use of a cooking knife. The retailer may want to avoid the display of advertisements associated with the retailer's store, to avoid any negative association. In another example, a computer software company may want to display relevant advertisements for a specific type of software. After reviewing the advertisements, the company may desire more targeted advertisements to a particular software. Through an embodiment of the present invention, the company may fine tune the results to focus on the advertisements by entering terms such as “linux, open source software.”

At block 218, the user may view or test the results of the specified adjustments. If the user is not satisfied at block 220, further modifications may be made, as shown by 222. The user may adjust the criteria as well as the target. If the user is satisfied, the criteria may be applied to the target. The user may also specify the duration of the applied adjustments. The adjusted advertisements may be displayed for a time period, such as a few hours, day(s), week(s), indefinitely, etc.

Through an embodiment of the present invention, users have the ability to view a targeted set of advertisements that will appear against their content by default and also have the ability to selectively adjust the next advertisements that would be served. The user (e.g., site owner) may access an interface to customize the advertisements for content for a period of time.

Illustrative System Environment

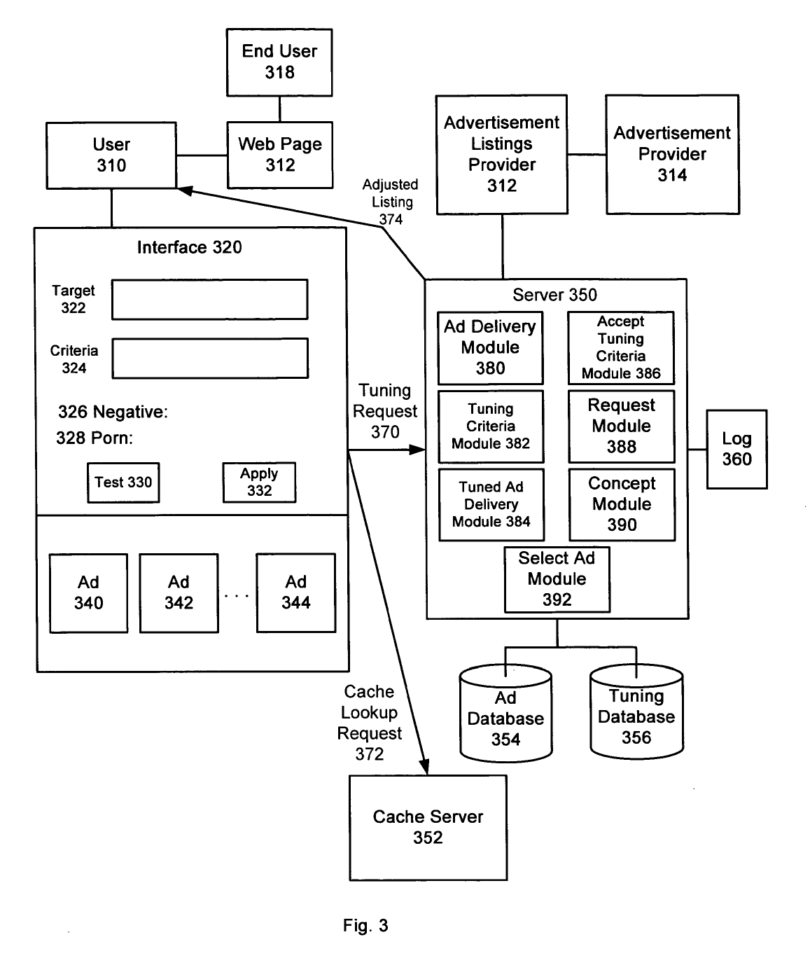

FIG. 3 is an exemplary diagram illustrating a system for adjusting the display of advertisements, according to an embodiment of the present invention. The tuning ability of an embodiment of the present invention allows users to change advertisement targeting for a target site, such as URLs, domains and/or properties. According to one example, publisher tuning may replace the criteria that are used to produce advertisements as well as mark or unmark pages as offensive, such as negative, porn, etc. An exemplary infrastructure may be implemented so that adding new publisher tuning abilities is facilitated. In addition, more complicated abilities may be allowed, such as adding hints, removing bad criteria/concepts, implementing backup criteria, etc. Changes made via publisher tuning may immediately take affect for some or all queries in some or all datacenters.

As shown in FIG. 3, a user 310 may access a system of an embodiment of the present invention through an interface 320. User 310 may represent an entity that supports a web site or other interface that displays one or more advertisements. Users may also include publishers, account managers, Internet advertising distribution partner, etc. Via interface 320, a user may enter a target, criteria and/or other information to adjust the display of advertisements. The data gathered may be compiled into a tuning request. The tuning request may be transmitted to a Server 350, which may access or save data to one or more databases 354, 356 and/or a server log 360. A cache lookup request 372 may be transmitted to Cache Server 352. Advertisements Listings Provider 312, Advertisement Provider 314 and/or other entities may access Server 350. End users 314 may view the selectively adjusted advertisements displayed on a web page 312 generated by user 310. While some of the component are shown as a single unit, the components may be duplicated in accordance with various embodiments of the present inventions. While the components are shown as separate, they may be combined in accordance with various embodiments of the present invention.

Server 350 may be separate from or combined with Advertisement Listings Provider 312. Server 350 may include various modules associated with tuning advertisements to be delivered to a distribution system for display to a user. For example, Server 350 may include Ad Delivery Module 380, Tuning Criteria Module 382, Tuned Ad Delivery Module 384, Accept Tuning Criteria Module 386, Request Module 388, Concept Module 390, Select Ad Module 392 and/or other modules.

Ad Delivery Module 380 may deliver one or more advertisements from a database, such as Ad Database 354, of available advertisements related to a concept to a user, such as user 310. The concept may be requested by the user. In another example, the concepts may be automatically or manually extracted from the web page 312. The advertisements may be delivered to User 310 for display on a web page 312 (or other target) associated with User 310. The web page with the advertisements may be displayed to various end users, as illustrated by 314.

Tuning Criteria Module 382 may receive one or more tuning criteria from the user. The tuning criteria may be received through Interface 320 where the tuning criteria may be received in Tuning Request 370. The user may enter various criteria to further narrow the advertisements. The user may also select categories of tuning, such as negative, porn, offensive, etc.

Tuned Ad Delivery Module 384 may delivery one or more advertisements to the user from the database, such as Ad Database 354, related to the concept and based on the one or more tuning criteria. By applying the tuning criteria to the advertisements, the user is able to selectively focus the advertisements for display on the user's web page (or other target). The adjusted advertisements may be forwarded to the user, as shown by adjusted listing 374, for display on web page 312.

Accept Tuning Criteria Module may accept the tuning criteria for use in delivering advertisements to the distribution system. The tuning criteria may be stored in a database, such as Tuning Database 356, and applied for a period of time, which may be selected by the user. In addition, the tuning criteria may apply until a new set of tuning criteria is applied.

According to another exemplary embodiment, advertisements may be distributed from an advertisement system to a distribution system that displays advertisements to users. Request Module 388 may receiving a request for advertisements from a distribution system. Concept Module 390 may identify one or more concepts for advertisements to be delivered and tuning criteria of the distribution system requesting advertisements. Based on the concepts and the tuning criteria, advertisements may be selected for delivery to the distribution system, via Select Ad Module 392.

A system of an embodiment of the present invention may submit a tuning request 370 to a separate server 350 in parallel with a cache lookup request 372. The tuning request 370 may contain multiple keys for url, property, domain, etc. The server 350 may return the latest tuning settings for each of these keys. An appropriate set of advertisements may be generated for the data found in the records. In general, tuning data will trump cache data. For example, if cache data has one set of criteria and tuning data has another, the tuning criteria will be used. Other rules may be established to determined the display of advertisements. The tuning data format and its use are detailed below.

The criteria may replace those generated by the normal content advertisement targeting. Multiple criteria may be sent together in a single query, separated by a operators, such as “or,” “and,” etc. In addition, multiple queries may be used. If multiple sets of replacement criteria are specified, one of the sets may be picked at random. Other rules for identifying criteria may also be established.

Criteria may be specified through interface 320. For example, a user may identify a target at 322. The target may include a specific web page, an aggregate of sites or any other target site. Users may also identify domains, properties or other identification or category of a target. The user may identify criteria at 324. The criteria may include keywords, concepts or any other terms. The user may enter a string of criteria, in various formats. Predetermined rules may then apply the string of criteria to adjust the display of the advertisements.

Internet advertising distribution partners and other users may adjust the listings on an Internet site (or other site) for various reasons. For example, an Internet advertising distribution partner, such as www.disney.com, may wish to be family friendly and may therefore wish to exclude any listings with the word “sex” in any of the listing's text or avoid any negative association. The Internet advertising distribution partner disney.com may submit a request for adjusted listings to the advertisement listings provider with criteria to exclude “sex” and/or other terms, phrases and/or concepts.

In another example, an Internet advertising distribution partner 205, WebMD, may request advertisement listings which contain the word “health” in the text of the advertisement listing. WebMD may fine tune the advertisements specifying additional, more specific terms or phrases, such as “weight loss,” “exercise,” and “diet.” These terms may replace the current criteria. In addition, the criteria may further narrow the current set of advertisements.

In addition, a user may select to mark or unmark a page (or other target) as offensive. For example, the publisher may select to mark one or more pages as negative 326, porn 328, etc. Other categories for offensive or other material may also be established. In addition, criteria may be used as a backup when the content is not available. User specified criteria may trump other alternative targeting methods. After selecting the desired criteria, the criteria may be tested, by selecting test 330. Resulting advertisements may be displayed to the user as shown by 340, 342, 344. If the user is satisfied with the results, the specified criteria may be applied to the target, by selecting 332. In addition, the user may also specify a time period for the advertisement adjustment. The infrastructure of an embodiment of the present invention may allow for various scoring adjustments and/or tweaks.

Hints work the same as hints sent with the request but may be part of tuning data. This will allow hints to be more easily set and managed. Hints may include text sent along with the request that may be incorporated into the targeting but will not completely replace the actual page content. For example, hints may be used to modify targeting on a per-request non-permanent basis. This is complementary to having hints preset (e.g., in a database using a Frontend UI) for that publisher, domain or URL.

An exemplary tuning data format which may include tuning data for a single key may be in a data structure, as detailed below:

```
PubTuning {
  string url = #;
  string domain = #;
  string property = #;
  group ReplacementCriteriaGroup = # {
  string replacement_criteria = #;
  }
  bool is_negative = #;
  bool is_porn = #;
}
```

Additional parameters may be modified, deleted or added as desired.

According to an exemplary embodiment, interface 320 may include a simple common gateway interface (cgi) script that allows testing of changes and appends the changes to log 360 (e.g., a server log) when applied. The changes may be applied to database 354, 356 and/or other form of storage. Most outward facing frontends prefer to talk to a database rather than a production server. Therefore, it may be desirable to write publisher tuning structures to a database in addition to the log.

According to exemplary application, the publisher tuning may allow re-mappings from a badly performing concept to one that performs better. For example, advertisements on some concepts may not perform well when targeted to pages about that content. Instead of showing advertisements directly about that concept, advertisements may be shown for a related concept that is more commercial or more likely to appeal to people viewing the content.

In addition to advertisements, other documents may be targeted to search results and/or content pages (e.g., web pages, emails, print media, etc.) on a wide variety of sites and other display environments. While the term “advertisement” and “ad” may be used as an illustrative example, it should be appreciated that the same system and method may be applied to other forms of documents or electronic documents. As used herein, the term “document” and “electronic document” may encompass one or more advertisements, content pages (e.g., web pages), search results, emails, applications, IM messages, audio content or files, video content or files, other files, other data or applications that may reside on one or several (e.g., a network) of computer systems, or other definable concepts or content. A “document” may also comprise a portion of a document.

While the foregoing description includes details and specificities, it should be understood that such details and specificities have been included for the purposes of explanation only, and are not to be interpreted as limitations of the present invention. Many modifications to the embodiments described above can be made without departing from the spirit and scope of the invention, as it is intended to be encompassed by the following claims and their legal equivalents.

What is claimed is:

1. A method of tuning advertisements comprising:
delivering to a user a first set of one or more advertisements related to a concept from a database of advertisements;
receiving one or more tuning criteria from the user;
delivering a second set of one or more advertisements to the user from the database, the second set of advertisements related to the concept and based on the one or more tuning criteria; and
applying the tuning criteria for use in delivering future sets of advertisements.

2. The method of claim 1, further comprising:
applying the one or more tuning criteria to future requests from the distribution system.

3. The method of claim 1, wherein the one or more tuning criteria comprises user input regarding indication of offensive material.

4. The method of claim 3, wherein the offensive material comprises pornographic subject matter.

5. The method of claim 3, wherein the offensive material comprises negative associations.

6. The method of claim 1, wherein the one or more tuning criteria is applied to one or more specified target sites.

7. The method of claim 1, wherein the one or more tuning criteria is updated.

8. The method of claim 7, wherein the updated tuning criteria comprises refined tuning criteria for adjusting the one or more advertisements for display.

9. A method of distributing advertisements comprising:
receiving a request for advertisements from a distribution system;
identifying at least one concept for advertisements to be delivered;
identifying tuning criteria of the distribution system requesting advertisements; and
selecting advertisements based on the at least one concept and the tuning criteria.

10. The method of claim 9, further comprising:
applying the one or more tuning criteria to future requests from the distribution system.

11. The method of claim 9, wherein the one or more tuning criteria comprises user input regarding indication of offensive material.

12. The method of claim 11, wherein the offensive material comprises pornographic subject matter.

13. The method of claim 11, wherein the offensive material comprises negative associations.

14. The method of claim 9, wherein the tuning criteria is applied to one or more specified target sites.

15. The method of claim 9, wherein the tuning criteria is updated.

16. The method of claim 15, wherein the updated tuning criteria comprises refined tuning criteria for adjusting the one or more advertisements for display.

17. A system of tuning advertisements comprising:
an ad delivery module for delivering to a user a first set of one or more advertisements related to a concept from a database of advertisements;
a tuning criteria module for receiving one or more tuning criteria from the user;
a tuned ad delivery module for delivering a second set of one or more advertisements to the user from the database, the second set of advertisements related to the concept and based on the one or more tuning criteria; and
an accept criteria module for applying the tuning criteria for use in delivering future sets of advertisements.

18. The system of claim 17, wherein the one or more tuning criteria are applied to future requests from the distribution system.

19. The system of claim 17, wherein the one or more tuning criteria comprises user input regarding indication of offensive material.

20. The system of claim 19, wherein the offensive material comprises pornographic subject matter.

21. The system of claim 19, wherein the offensive material comprises negative associations.

22. The system of claim 17, wherein the one or more tuning criteria is applied to one or more specified target sites.

23. The system of claim 17, wherein the one or more tuning criteria is updated.

24. The system of claim 23, wherein the updated tuning criteria comprises refined tuning criteria for adjusting the one or more advertisements for display.

25. A system of distributing advertisements comprising:
request module for receiving a request for advertisements from a distribution system;
a concept module for identifying at least one concept for advertisements to be delivered and identifying tuning criteria of the distribution system requesting advertisements; and
a select ad module for selecting advertisements based on the at least one concept and the tuning criteria.

26. The system of claim 25, wherein the one or more tuning criteria are applied to future requests from the distribution system.

27. The system of claim 25, wherein the one or more tuning criteria comprises user input regarding indication of offensive material.

28. The system of claim 27, wherein the offensive material comprises pornographic subject matter.

29. The system of claim 27, wherein the offensive material comprises negative associations.

30. The system of claim 25, wherein the tuning criteria is applied to one or more specified target sites.

31. The system of claim 25, wherein the tuning criteria is updated.

32. The system of claim 31, wherein the updated tuning criteria comprises refined tuning criteria for adjusting the one or more advertisements for display.

33. A method of tuning documents comprising:
delivering to a user a first set of one or more documents related to a concept from a database of documents;
receiving one or more tuning criteria from the user;
delivering a second set of one or more documents to the user from the database, the second set of documents related to the concept and based on the one or more tuning criteria; and
applying the tuning criteria for use in delivering future sets of documents.

34. A method of distributing documents comprising:
receiving a request for documents from a distribution system;
identifying at least one concept for documents to be delivered;
identifying tuning criteria of the distribution system requesting documents; and
selecting documents based on the at least one concept and the tuning criteria.

35. A system of tuning documents comprising:
an ad delivery module for delivering to a user a first set of one or more documents related to a concept from a database of documents;
a tuning criteria module for receiving one or more tuning criteria from the user;
a tuned ad delivery module for delivering a second set of one or more documents to the user from the database, the second set of documents related to the concept and based on the one or more tuning criteria; and
an accept criteria module for applying the tuning criteria for use in delivering future sets of documents.

36. A system of distributing documents comprising:
request module for receiving a request for documents from a distribution system;
a concept module for identifying at least one concept for documents to be delivered and identifying tuning criteria of the distribution system requesting documents; and
a select ad module for selecting documents based on the at least one concept and the tuning criteria.
